(19) United States
(12) Patent Application Publication
(10) Pub. No.: US 2002/0166685 A1
(43) Pub. Date: Nov. 14, 2002

(54) Circuit element mounting board and circuit element mounting method

(75) Inventors: Kikuji Miyamura, Kuwana-shi (JP); Susumu Nomoto, Nagoya-shi (JP); Mitsuo Nakahashi, Nagoya-shi (JP); Takahiro Kawai, Kani-shi (JP)

Correspondence Address: BURR & BROWN, PO BOX 7068, SYRACUSE, NY, 13261-7068, US

(73) Assignee: NGK Insulators, Ltd., Nagoya-shi (JP)

(21) Appl. No.: 09/973,672

(22) Filed: Jan. 24, 2002

(30) Foreign Application Priority Data
Oct. 12, 2000 (JP) 2000-312470

(51) Int. Cl. H02G 3/08

(52) U.S. Cl. 174/52.1

(57) ABSTRACT

The invention provides a technique for mounting circuit elements, in which short circuits between the electrodes of the circuit element do not occur when using silver paste to mount the circuit element. On a board 1 between conductors 2 on which a circuit element 4 is mounted, an insulating resin layer 6 is formed, which is about twice as wide as the circuit element 4, and has a thickness that fills the gap between the mounted circuit element 4 and the board 1. The insulating resin layer 6 is made of a resin whose curing speed is faster than that of a silver paste 5, and is cured at the same time as the curing step of the silver paste 5.

### BACKGROUND OF THE INVENTION

1. Field of the Invention

The present invention relates to a technique for mounting a chip type circuit element, such as a chip resistor or a capacitor, on a board, and more specifically, to a technique for mounting circuit elements, in which no short circuits occur between the element terminals on the board, when the circuit elements are adhesively mounted by silver paste.

2. Description of the Related Art

FIG. 5 shows a longitudinal cross section of a circuit element mounting portion of a conventional mounting board. On this board, a circuit is provided and a circuit element is mounted. In FIG. 5, numeral 11 denotes a board made of an insulating material, numeral 12 denotes a conductor, numeral 13 denotes a conductive paste, and a circuit element 14 is fixed on the conductor 12 by the conductive paste 13 to form a circuit on the board.

For the conductive paste 13 mentioned above, silver paste is widely used, because it is superior with regard to reliability and costs. Furthermore, it is superior with regard to the ease with which fine patterns can be formed. However, silver paste has the property of being much more flowable than solder paste, so that, sometimes short circuits between the terminals of the mounted element occurs. One of the considerable cases of the short circuits is that a portion of the silver paste pushed out flows out guided along the mounted circuit element 14 by capillary effects, when a circuit element 14 is mounted on the board 11. Another case is that a portion of the silver paste flows out over the surrounding of conductor 12 due to bleeding effects.

In view of these problems, it is an object of the present invention to provide a circuit element mounting board and a circuit element mounting method, in which no short circuits occur between the electrodes of the circuit element, even when using silver paste to mount the circuit element.

### SUMMARY OF THE INVENTION

In order to solve these problems, in a circuit element mounting board according to a first aspect of the present invention, a circuit element mounting board, comprising; conductors of conductive film which are provided on the board; and circuit elements which are electrically connected to the conductors by mounting the between the conductors; wherein the circuit element is attached to the conductors by silver paste; and an insulating resin layer is provided on the board between the conductors below the circuit element.

According to a second aspect of the present invention, in a circuit element mounting board as in the first aspect, the circuit element is mounted on lands, made by forming the conductors more widely.

According to a third aspect of the present invention, in a circuit element mounting board as in the first or second aspect, the width of the insulating resin layer is 1.5 to 4 times the width of the mounted circuit element.

According to a fourth aspect of the present invention, a circuit element mounting method which includes a process of providing conductors of conductive film on a board, and electrically connecting a circuit element to the conductors by mounting the circuit element between the conductors, comprising the steps of, forming an insulating resin layer on the board between the conductors below the circuit element and disposing a silver paste on the conductors at a circuit element mounting position; mounting the circuit element, spanning the insulating resin layer, on the portion on which silver paste has been disposed; and attaching the circuit element to the conductors by curing the insulating resin layer and the silver paste after mounting the circuit element.

According to a fifth aspect of the present invention, in a circuit element mounting method according to the fourth aspect, a curing speed of the insulating resin layer is equivalent to or faster than a curing speed of the silver paste.

### BRIEF DESCRIPTION OF THE DRAWINGS

FIG. 1 illustrates the relevant parts of a circuit element mounting board as an example of an embodiment of the present invention.

FIG. 1(a) is a top view of the portion where the circuit element is mounted, and

FIG. 2(b) is a longitudinal cross section of the circuit element mounting portion.

FIG. 2 shows alternative shapes of the insulating resin layer.

FIG. 3 illustrates the relevant parts of a circuit element mounting board of another embodiment for preventing the flow of silver paste.

FIG. 3(a) is a top view of the portion where the circuit element is mounted, and

FIG. 3(b) is a longitudinal cross section of the circuit element mounting portion.

FIG. 4 illustrates the relevant parts of a circuit element mounting board of another embodiment for preventing the flow of silver paste.

FIG. 4(a) is a top view of the portion where the circuit element is mounted, and

FIG. 4(b) is a longitudinal cross section of the circuit element mounting portion.

FIG. 5 shows a cross sectional diagram of a conventional circuit element mounting portion.

### DESCRIPTION OF THE PREFERRED EMBODIMENTS

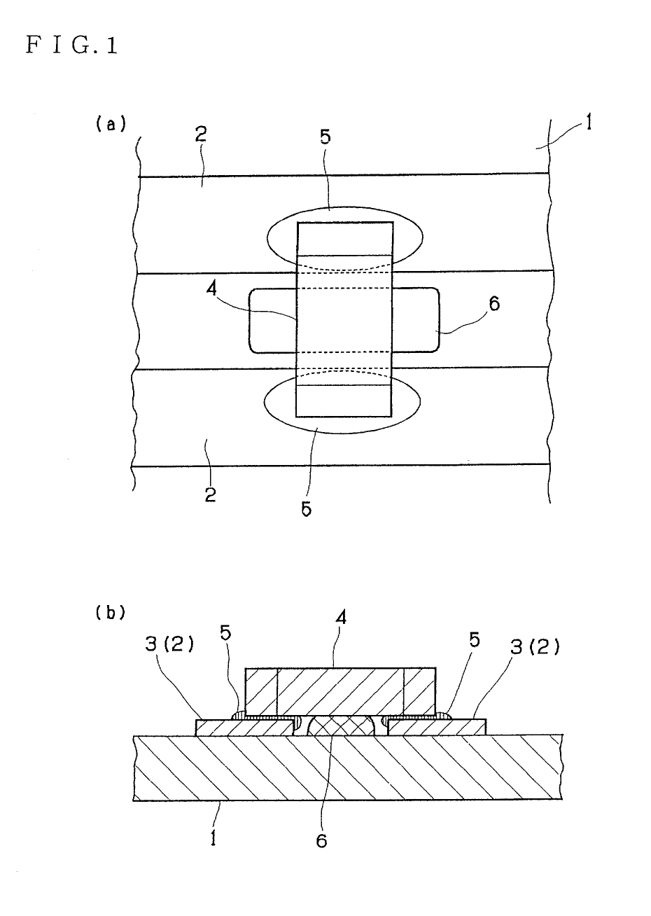

The following is a detailed description of a specific embodiment of the present invention, with reference to the accompanying drawings. FIG. 1 shows an example of a circuit element mounting board in accordance with the present invention. FIG. 1(a) is a top view of the relevant portions where the circuit element is mounted. FIG. 1(b) is a cross sectional diagram taken in longitudinal direction along the element. In the drawings, numeral 1 denotes a board made of an insulating material, numeral 2 denotes a conductor, numeral 4 denotes a circuit element, numeral 5 denotes a silver paste, and numeral 6 denotes an insulating resin layer.

By a film forming means such as means applied in a printing, the conductor 2 is formed with a conductive resin including a metal, such as silver or copper, as its principal component. Then the conductive resin is cured, and a pattern of a circuit is composed. Moreover, the conductor 2 is formed at a width that allows for easy connection of the circuit element 4.

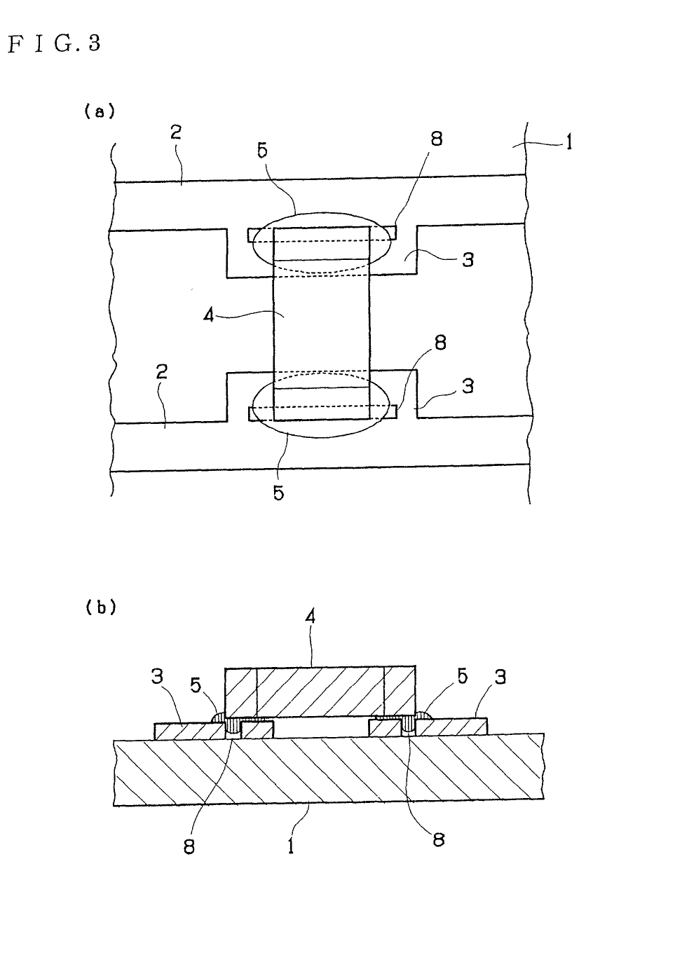

It should be noted that the conductor 2 can also be formed by forming a metal film, such as a copper foil, on the board and etching the film. Moreover, if the conductor pattern is not formed sufficiently wide, then it is also possible to mount the circuit element on lands 3 formed by making the conductor wider, in accordance with the size of the electrodes of the circuit element for connecting the circuit element, as shown in FIG. 3, which is explained below.

Then, the insulating resin layer 6 is formed on the board 1 between the conductors 2,2. The circuit element 4 is attached with the silver paste 5 between the conductors 2,2, straddling the insulating resin layer 6. Providing a small gap from the conductors 2, the insulating resin layer 6 is formed on the board 1 as an oblong rectangle. The layer 6 has approximately twice the width of the circuit element 4, and has a thickness that brings it into contact with the mounted circuit element 4.

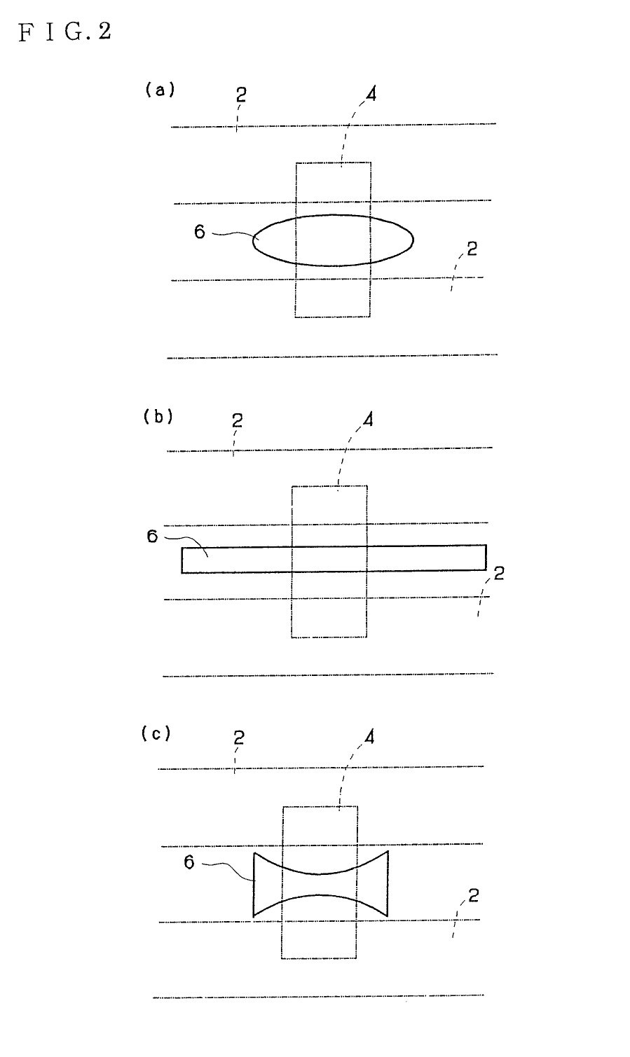

FIG. 2 shows alternative shapes of the insulating resin layer 6. As shown in FIG. 2(a), the insulating resin layer 6 can also be elliptical, and as shown in FIG. 2(b), it can also be even more oblong. Furthermore, it can also be contracted at its center to provide a portion where liquid can accumulate, as shown in FIG. 2(c). In all these cases, it is better to form with a width of 1.5 to 4 times the width of the circuit element.

By arranging the insulating resin layer in these manners, the insulating resin layer provided between the conductors acts as a dike stemming the flow of the silver paste, even when the silver paste disposed on the conductor flows out due to bleeding or capillary effects. As a result, no short circuits occur between the conductors due to the flowing of silver paste.

Moreover, by making the width of the insulating resin layer at least 1.5 times the width of the circuit element, short circuits due to the flowing of the silver paste can be prevented. However, a width of not more than four times is sufficient, and if its width is not more than four times the width of the circuit element, the insulating resin layer can be formed in an application step similar to that of the silver paste, which makes its formation easy.

The following is an explanation of a procedure for forming the insulating resin layer. The formation of the insulating resin layer 6 can be carried out in a step before or after the step of applying the silver paste, or it can be carried out in the same step. A board 1 with the conductors 2 is prepared, and insulating resin is printed (applied) at predetermined locations by a printing method using a transfer pin, for example, as for the silver paste. Then, after application of the insulating resin and the silver paste, the circuit element 4 is mounted, and the resin and the silver paste are cured.

It should be noted that it is advantageous to use a resin which cures faster than the silver paste 5 as for the insulating resin, because the insulating resin is cured completely in the curing step of the silver paste. It is also acceptable if the curing speed of the insulating resin is the same as that of the silver paste 5. If a resin that has the same curing time as that of the silver paste 5 is used, it is able to use the same resin as which is included in the silver paste.

Because the insulating resin can be formed with the same curing and application step as the silver paste, the manufacturing steps are not complex. Furthermore, the insulating resin layer is cured while it is in contact with the circuit element, so that no silver paste flows between the circuit element and the insulating resin layer.

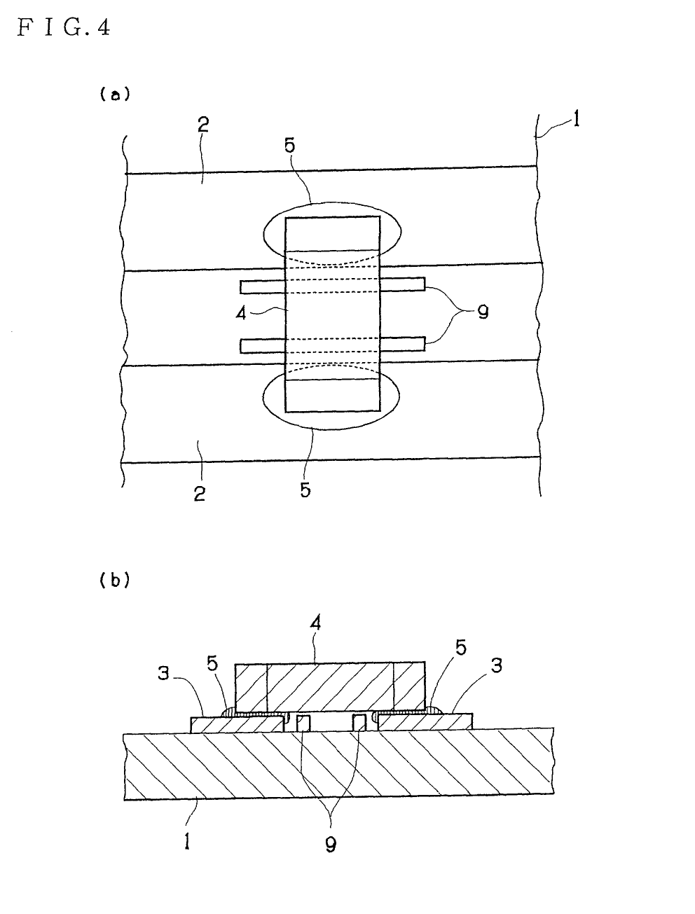

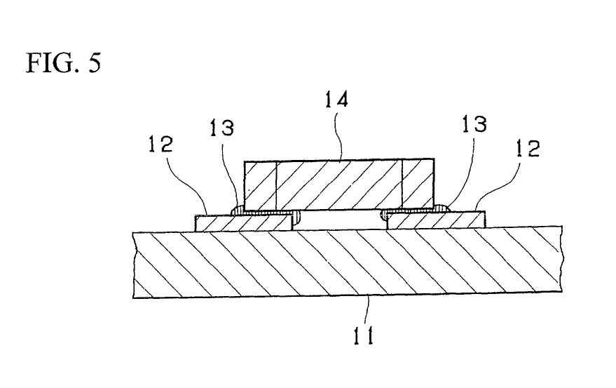

FIG. 3 and FIG. 4 show another structure preventing short circuits between the conductors due to the flowing of silver paste. FIGS. 3(a) and 4(a) are diagrammatic top views and FIGS. 3(b) and 4(b) are cross sectional diagrams taken in longitudinal direction along the element. In FIG. 3, numeral 3 denotes lands for mounting the circuit element, which are formed by making the conductors wider. These lands 3 are provided with recess portions 8. The recess portions 8 are made by forming oblong grooves extending beyond the circuit element 4 at positions corresponding to the electrode terminals of the circuit element 4. The board 1 is exposed at the bottom of these grooves.

Thus, with these recess portions 8, liquid accumulation portions, are provided inside the conductors 3, so that even without providing an insulating resin layer between the conductors, flowing silver paste flows into the recess portions 8. Consequently, there is no extensive flowing of silver paste, and short circuits do not occur. Furthermore, even when the conductors are narrow, the circuit element can be mounted easily by providing the portions to which the circuit element is connected with wide lands.

In FIG. 4, instead of the insulating resin layer 6, dikes 9 that are shaped as oblong bars are formed between the conductors 2,2, using the same conductive material as for the conductors 2. By forming such dikes 9, it is possible to prevent short circuits due to the flowing of the silver paste 5, without changing the shape of the conductors 2 and without providing the insulating resin layer 6. Thus, only the conductor pattern is changed and a synthetic resin layer is not necessary, so that it is not necessary to change the conventional manufacturing steps.

As explained in detail above, with the circuit element mounting board according to the first and the second aspect of the present invention, when silver paste disposed on the conductors flows out due to bleeding and capillary effects, the insulating resin layer provided between the conductors can stem this flow, so that the silver paste will not cause short circuits between the conductors.

According to the third aspect of the present invention, in addition to the effects of the first aspect, the silver paste can be reliably prevented from flowing beyond the insulating resin layer. In this aspect, the insulating resin layer is wider than the circuit element. Further, the insulating resin layer can be formed with an application step similar to that of the silver paste, and the insulating resin layer can be formed easily.

With the circuit element mounting method according to the fourth aspect of the present invention, the curing of the insulating resin layer is performed simultaneously with the curing of the silver paste, so that short circuits between the conductors can be prevented without complex manufacturing steps. According to the fifth aspect of the present invention, in the step of curing the silver paste, the insulating resin layer is cured even more reliably.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description. All changes that come within the meaning and range of equivalency of the claims are intended to be embraced therein.

What is claimed is:

1. A circuit element mounting board, comprising;
conductors of conductive film which are provided on the board;
and circuit elements which are electrically connected to the conductors by mounting the between the conductors;
wherein the circuit element is attached to the conductors by silver paste;
and an insulating resin layer is provided on the board between the conductors below the circuit element.

2. The circuit element mounting board according to claim 1, wherein the circuit element is mounted on lands, made by forming the conductors more widely.

3. The circuit element mounting board according to claim 1 or claim 2, wherein the width of the insulating resin layer is 1.5 to 4 times the width of the mounted circuit element.

4. A circuit element mounting method which includes a process of providing conductors of conductive film on a board, and electrically connecting a circuit element to the conductors by mounting the circuit element between the conductors, comprising the steps of;
forming an insulating resin layer on the board between the conductors below the circuit element and disposing a silver paste on the conductors at a circuit element mounting position;
mounting the circuit element, spanning the insulating resin layer, on the portion on which silver paste has been disposed; and
attaching the circuit element to the conductors by curing the insulating resin layer and the silver paste after mounting the circuit element.

5. The circuit element mounting method according to claim 4, wherein a curing speed of the insulating resin layer is equivalent to or faster than a curing speed of the silver paste.
